(19) United States
(12) Patent Application Publication
(10) Pub. No.: US 2003/0193176 A1
(43) Pub. Date: Oct. 16, 2003

(54) Vehicle with a child seat arranged in the front or the back

(76) Inventors: Christian Ott, Langen (DE); Wolfgang Schumacher, Russelsheim (DE)

Correspondence Address: LAURA C. HARGITT, General Motors Corporation, Legal Staff, Mail Code 482-C23-B21, P.O. Box 300, Detroit, MI, 48265-3000, US

(21) Appl. No.: 10/337,926

(22) Filed: Jan. 7, 2003

(30) Foreign Application Priority Data
Apr. 12, 2002 (DE) 10216111.9

(51) Int. Cl. B60R 21/22; B60R 21/32

(52) U.S. Cl. 280/735; 280/730.2

(57) ABSTRACT

For the most child-specific protection possible in the case of an accident according the invention in a vehicle a control device (24) identifying a child seat (32++ ) and/or an activated childproof safety lock (30) is provided which is connected to an airbag system (2) providing side protection in such a way that when the childproof safety lock (30) is activated and/or the child seat (32) is identified the airbag system (2) can be detected.

### DESCRIPTION

The invention concerns a vehicle with a child seat arranged in the front or the back and with a childproof safety lock for a rear or front door which, when the childproof safety lock is activated, can only be unlocked from the outside and is locked from the inside.

For example, from DE 44 42 530 A1 a vehicle is known in which a child seat can be installed in a functional position on the rear seat. To activate the childproof safety lock in the rear part of the vehicle, manually activated switches are provided. Furthermore, on the rear seat a contact switch is arranged which is connected to a vehicle-wide communications network to which several child-specific comfort or safety functions are connected. When a child seat is installed, the contact switch is activated so that the child-specific safety functions are activated.

From AUTOBILD No. 41, Oct. 13, 2000, p.46-48 it is known that vehicles can be equipped with side airbags for protection in side collisions. These side airbags are essentially intended to protect the head and upper body along the roof segment of the door or the seat backrest.

The invention is based on the consideration that a passenger-specific and therefore individual adjustment and actuation of an airbag system serving for side protection inside the vehicle is provided. At the same time the activation of an airbag system should take place independently of whether the child seat is already integrated into the vehicle and merely brought into its functioning or readiness position or whether the child seat is independently installed in the vehicle and is brought into its readiness or functional position accordingly. For this purpose a control device is provided which identifies a child seat and/or the activated childproof safety lock, which is connected to the airbag system producing side protection. In this case the airbag system is connected to the control device in such a way that upon activation of the childproof safety lock and/or when the child seat is identified, the airbag system can be deactivated. The position of the childproof safety lock is preferably determined relative to the door by the control device. Moreover, the airbag system can remain switched on when an adult is in the rear part of the car.

Advisably the airbag system can be deactivated relative to the seat. For example the airbag system can be deactivated only if a control device on a seat identifies a child seat or an activated childproof safety lock on one of the side doors. In a preferred variant an airbag arranged in the head region along the roof of the vehicle can be deactivated separately.

In addition in the case of a child seat of integrated design the airbag systems can all be deactivated relative to the position of the child seat. For example the airbag system can be deactivated only when the child seat is brought into its functional or readiness position. To identify the child seat installed in the front or the back, i.e., an independently installed child seat, advisably a contact element is provided, upon the actuation of which the airbag system is deactivated. Therefore the actuation of the airbag system only occurs when the integrated child seat or the independently installed child seat has been brought into the envisioned functional position; otherwise no deactivation of the airbag system takes place.

Alternatively or additionally, an actuation means is provided for manual deactivation of the airbag system. Depending on the type and design of the vehicle the actuation means is preferably arranged centrally, for example, on the driver's console. In this way the airbag system or individual side airbags can be deactivated by the driver himself. The actuation means, however, as in the case of a conventional childproof safety lock, can be provided for each vehicle door and therefore relative to the seat. For a simple review of the current state of the airbag system advisably an indicator is provided. As an indicator, for example, one can use the onboard computer or another optical indicator which is arranged in the viewing area of the driver, e.g., in the instrument panel.

Identification of a child seat placed in functional readiness or an activated childproof safety lock and the resulting deactivation of the corresponding airbag or airbag system, the contact element and the childproof safety lock are connected by a data bus system to the control device. The actuation means as well as the indicator are preferably connected to the control device through the data bus system.

The advantages achieved by the invention are, in particular, the fact that by connecting the child-relevant measures or devices such as a child seat and/or an activated childproof safety lock to the control device for triggering the airbag system a passenger-related and/or seat-related adjustment of the airbag system acting to produce side protection can be made possible in an especially simple way.

Examples of embodiments of the invention are explained in more detail with reference to the drawings, in which:

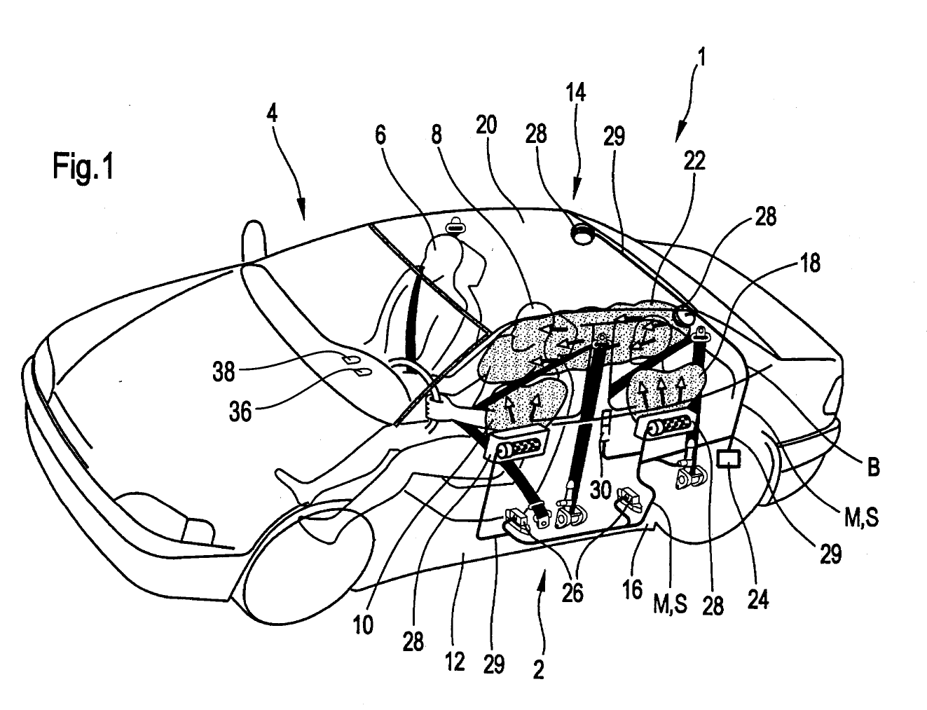

FIG. 1 shows schematically a vehicle in perspective view with a control device for identification of child-securing components and for deactivation of an airbag system, and

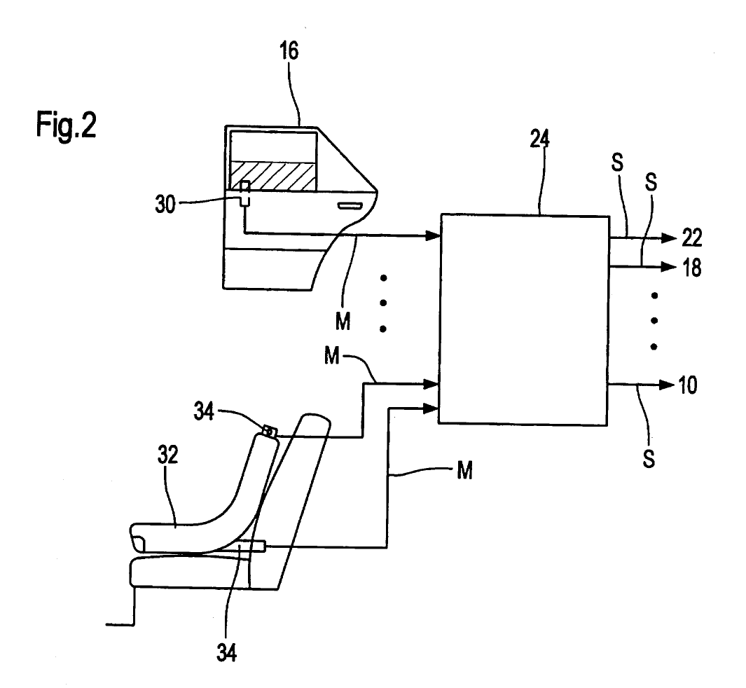

FIG. 2 shows schematically the control device in FIG. 1.

Corresponding parts in all figures are identified by the same reference numbers.

FIG. 1 shows a vehicle 1 in perspective view with an airbag system 2 to provide side protection. The airbag system 2 in the front area 4, especially in the area of a front passenger 6 or a driver 8, displays a side airbag 10 as side collision protection. The side airbag 10 is arranged in a side door 12 at the height of a door or seat backrest. In the rear area 14 the airbag system 2 for side collision protection includes another side airbag 18 arranged in the rear side door 16 and a corresponding side airbag 22 arranged in the head region along a roof 20.

One or more of the side airbags 10, 18, 22 are triggered by means of a control signal S emitted by a control device 24. In this case, measurement signals M from acceleration sensors 26 integrated in the side doors 12 and 16 are registered by the control device 24 which are then processed into a signal S triggering the side airbags 10, 18 or 22 respectively. In the event of a side collision identified by the corresponding acceleration sensors 26, the side airbags 10, 18 and/or 22 involved are unfolded through the intermediacy of the corresponding control signal by a gas generator 28 belonging to the side airbag 10, 18, 22 in question.

Depending on the nature and the design of the individual components—the control device 24, the acceleration sensors 26, the gas generator 28—are connected to each other by a connecting means 29. For example, they are connected to each other by a data bus system B, e.g., a vehicle-specific data bus system, the so-called CAN bus.

In the example shown in FIG. 1 the airbag system 2 is shown only for the driver's side of the vehicle 1. Depending on the nature of the vehicle 1 on the passenger-side, an essentially identical airbag system 2 can be provided.

For a differentiated, especially individual seat-related and/or passenger-specific activation of the side airbags 10, 18 and 22, the control device 24 is connected to a childproof safety lock 30. The control device 24 is shown schematically in FIG. 2. The position of the childproof safety lock 30 is identified relative to the door by the control device 24. In other words, the control device 24 is connected via the data bus system B to the childproof safety lock 30 integrated in the different side doors 12, 16. As an example, in FIG. 2 only the rear side door 16 shown. The control device 24 is also designed for identifying a child seat 32 installed in the back 14 or the front 4 of the vehicle.

Depending on the nature and the design of the child seat 32, in the case of a child seat 32 integrated in the vehicle, its position is determined. In the case of an independently installed child seat 32 in the front 4 or the back 14 at least one contact 34 is provided for identification of the installed child seat 32. In this case the contact element 34 is connected via the data bus system B to the control device 24. Therefore its position is determined by the control device 24 independently of the type of child seat 32, especially its installation in a functional position.

If a child seat 32 in the functional position is identified by the control device 24 the airbag system 2 is deactivated. Depending on the nature and the design of the control device 24 the airbag system 2 is deactivated relative to the seat. For example, in the case of a child seat 32 installed only on the rear seat the corresponding side airbag 18 of the rear side door 16 in question is deactivated.

Alternatively or additionally, instead of the identification of an operationally ready child seat 32, the activated childproof safety lock 30 is used for deactivation of the airbag system 2, especially for deactivation of the corresponding side airbags 10, 18 or 22. Such a seat-related or passenger-specific deactivation of the side airbags 10, 18, or 22 makes an individual adjustment of the safety measures possible.

In another preferred variant one or several side airbags 10, 18 and/or 22 can be deactivated manually by means of an activation device 36 such as a pushbutton switch. For example such a manual deactivation is provided for the driver of the vehicle 1. For this purpose the activation means 36 may be arranged centrally, e.g., in the driver's console, not shown in detail. In addition, the operating state of the airbag system 2 or the individual side airbags 10, 18 and/or 22 can be output via an indicator 38. For this purpose the indicator 38 is arranged, for example, centrally, especially in a position clearly visible to the driver of the vehicle 1, e.g., in a driver's console not shown in detail.

1. A vehicle (1) with a child seat (32) arranged in the front or the back (4) and with a childproof safety lock (30) for an adjacent door which can be unlocked from the outside when the childproof safety lock (30) is activated, comprising:
a control device (24) identifying at least one of the child seat (32) and the activated childproof safety lock (30) and is connected to a side airbag system (2) such that when the childproof safety lock (30) is activated or the child seat (32) is identified, the side airbag system (2) is deactivated.

2. A vehicle as in claim 1, wherein the airbag system (2) is deactivated relative to a seat.

3. A vehicle as in claim 1, wherein an airbag (22) of the airbag system arranged in a head region along a roof (20) can be deactivated separately.

4. A vehicle as in claim 1, wherein the child seat (32) is integrated design in the vehicle and the airbag system (2) can be deactivated with reference to its position.

5. A vehicle as in claim 1 further comprising a contact element (34) for identification of a child seat (32) independently installed in the front or the back, upon the activation of which the airbag system (2) is deactivated.

6. A vehicle as claim 1, further comprising an activation means (36) for manual deactivation of the airbag system (2).

7. A vehicle as in claim 6, wherein the activation means (36) for manual deactivation of the airbag system (2) is arranged centrally on a driver's console.

8. A vehicle as in claim 6, wherein the childproof safety lock (30), the contact element (34) and the activation means (36) are connected to the control device (24) by a data bus system (B).

9. A vehicle as claim 1, wherein the position of the childproof safety lock (30) relative to the door is determined by the control device (24).

10. A vehicle as in claim 1, further comprising an indicator means (38) for indicating the state of the airbag system (2).
